(19) United States
(12) Patent Application Publication
(10) Pub. No.: US 2004/0111432 A1
(43) Pub. Date: Jun. 10, 2004

(54) Apparatus and methods for semantic representation and retrieval of multimedia content

(75) Inventors: Hugh William Adams JR., Wappingers Falls, NY (US); Giridharan Iyengar, Mahopac, NY (US); Ching-Yung Lin, Forest Hills, NY (US); Milind R. Naphade, Urbana, IL (US); Chalapathy Venkata Neti, Yorktown Heights, NY (US); Harriet Jane Nock, Elmsford, NY (US); John Richard Smith, New York, NY (US); Belle L. Tseng, Forest Hills, NY (US)

Correspondence Address: DUKE. W. YEE, CARSTENS, YEE & CAHOON,L.L.P., P.O. BOX 802334, DALLAS, TX, 75380, US

(73) Assignee: International Business Machines Corporation, Armonk, NY (US)

(21) Appl. No.: 10/315,334

(22) Filed: Dec. 10, 2002

(51) Int. Cl. G06F 17/00; G06F 7/00

(52) U.S. Cl. 707/104.1

(57) ABSTRACT

An apparatus and method for analyzing multimedia content to identify the presence of audio, visual and textual cues that together correspond to one or more high-level semantics are provided. The apparatus and method make use of one or more analysis models that are trained to analyze audio, visual and textual portions of multimedia content to generate scores associated with the audio, visual and textual portions with respect to various high-level semantic concepts. These scores are used to generate a vector of scores. The apparatus is trained with regard to relationships between audio, visual and textual scores to thereby take the vector of scores generated for the multimedia content and classify the multimedia content into one or more high-level semantic concepts. Based on the scores for the various audio, video and textual portions of the multimedia content, a level of certainty regarding the high-level semantic concepts may be generated. These high-level semantic concepts are then used to generate one or more labels for the multimedia content that may be used to retrieve the multimedia content using a conceptual search engine. These semantic concept labels and their associated certainty levels may be stored in a file, associated with the multimedia content, for use in retrieving the multimedia content using the conceptual search engine.

### BACKGROUND OF THE INVENTION

1. Technical Field

The present invention is directed to an apparatus and method for semantic representation and retrieval of multimedia content. More specifically, the present invention is directed to an apparatus and method for identifying audio, visual and textual cues in multimedia content and generating a semantic representation of the multimedia content based on these cues.

2. Description of Related Art

The Internet has fast become a primary source of information in our society. One way in which users of computing devices obtain information from web sites on the Internet is to use a search engine to locate this information. Typically, the user must enter one or more text search terms and the search engine searches a list of keywords for each registered web site to determine if the text search terms are contained therein. Based on the number of search terms included in the list of keywords, and other criteria, the search engine may return a ranked list of search results to the computing device that sent the search request. A user may then select one of the web sites in the search results to thereby communicate with the web site and obtain the information desired.

Thus, with known systems, the manner by which information is obtained from web sites on the Internet is to perform a text comparison between search terms and sets of keywords associated with the web site. These text keywords are specified by the creator of the website or the search engines can also automatically scan websites, harvest the text contained therein and create a keyword representation. In addition, some search engines also analyze the links that come from one website to another to uncover important websites based on popularity and number of links etc.

It follows from the above that, unless the creator of the web site has foreseen all possible terms that may be used by a user to identify the web site and specifically use these terms in the pages that form the website, some users may not find the web site using a conventional search engine if the search terms have not been included in the set of keywords for the web site. Thus, the burden of correctly identifying the web site in the set of keywords lies on the creator of the web site and any deficiency in the set of keywords may result is less exposure of the web site to potential users.

Moreover, as multimedia content becomes more prevalent on the Internet, it is becoming a more important issue to represent the multimedia content in a way that users may find the multimedia content. The traditional search engine approach has been used with multimedia content in that a description of the multimedia content is generated, such as a set of keywords for the multimedia content. This description is then compared to the search terms entered by a user of a search engine to determine if any, and how many, of the search terms are included in the description of the multimedia content. Again, this requires that the supplier of the multimedia content predict all of the possible search terms that a user may enter into the search engine to find the multimedia content.

There is no mechanism in the known systems for analyzing multimedia content to identify high-level semantic representations of the multimedia content. Moreover, there is no search engine that allows a user to enter high-level concepts and obtain multimedia content corresponding to such high-level concepts based on the automatically generated semantic representations of the multimedia content.

Thus, it would be beneficial to have an improved apparatus and method for representing multimedia content in terms of high-level semantics. Moreover, it would be beneficial to have an apparatus and method for retrieving multimedia content based on high-level semantic concepts.

### SUMMARY OF THE INVENTION

The present invention provides an apparatus and method for analyzing multimedia content to identify the presence of audio, visual and textual cues that together correspond to one or more high-level semantics. The present invention makes use of one or more analysis models that are trained to analyze audio, visual and textual portions of multimedia content to generate scores associated with the audio, visual and textual portions with respect to various high-level semantic concepts. These scores are used to generate a vector of scores. The apparatus is trained with regard to relationships between audio, visual and textual scores to thereby take the vector of scores generated for the multimedia content and classify the multimedia content into one or more high-level semantic concepts. Based on the scores for the various audio, video and textual portions of the multimedia content, a level of certainty regarding the high-level semantic concepts may be generated.

These high-level semantic concepts are then used to generate one or more labels for the multimedia content that may be used to retrieve the multimedia content using a conceptual search engine. These semantic concept labels and their associated certainty levels may be stored in a file, associated with the multimedia content, for use in retrieving the multimedia content using the conceptual search engine.

A conceptual search engine is provided that allows a user to enter concepts rather than merely a string of search terms. For example, the user of the conceptual search engine of the present invention may enter a search request of “an interview at a rocket launch.” The conceptual search engine will then search the one or more labels for the multimedia content that has been classified, and identify the multimedia content that include rocket launches and interviews. The search engine may then rank the multimedia content identified through the search based on the confidence level associated with the labels of multimedia content. The ranked list of multimedia content may then be returned to the user as the results of the search. The user may then select a search result to thereby obtain access to the multimedia content.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary block diagram of a server computing device according to the present invention;

FIG. 3 is an exemplary block diagram of a client computing device according to the present invention;

FIG. 4 is a flowchart outlining an exemplary operation of the present invention when analyzing multimedia content to generate a high-level semantic representation of the multimedia content;

FIG. 5 is a flowchart outlining an exemplary operation of the present invention when retrieving multimedia content based on a high-level semantic representation of the multimedia content;

FIG. 6 is an exemplary block diagram of a multimedia content representation and retrieval device in accordance with the present invention; and

FIG. 7 is an exemplary diagram illustrating a search engine interface according to an exemplary embodiment of the present invention.

### DETAILED DESCRIPTION OF THE PREFERRED EMBODIMENT

The preferred embodiments of the present invention are implemented in a distributed data processing environment. Since the present invention is implemented in a distributed data processing environment, a brief description of this environment will first be provided in order to provide a context in which the present invention operates.

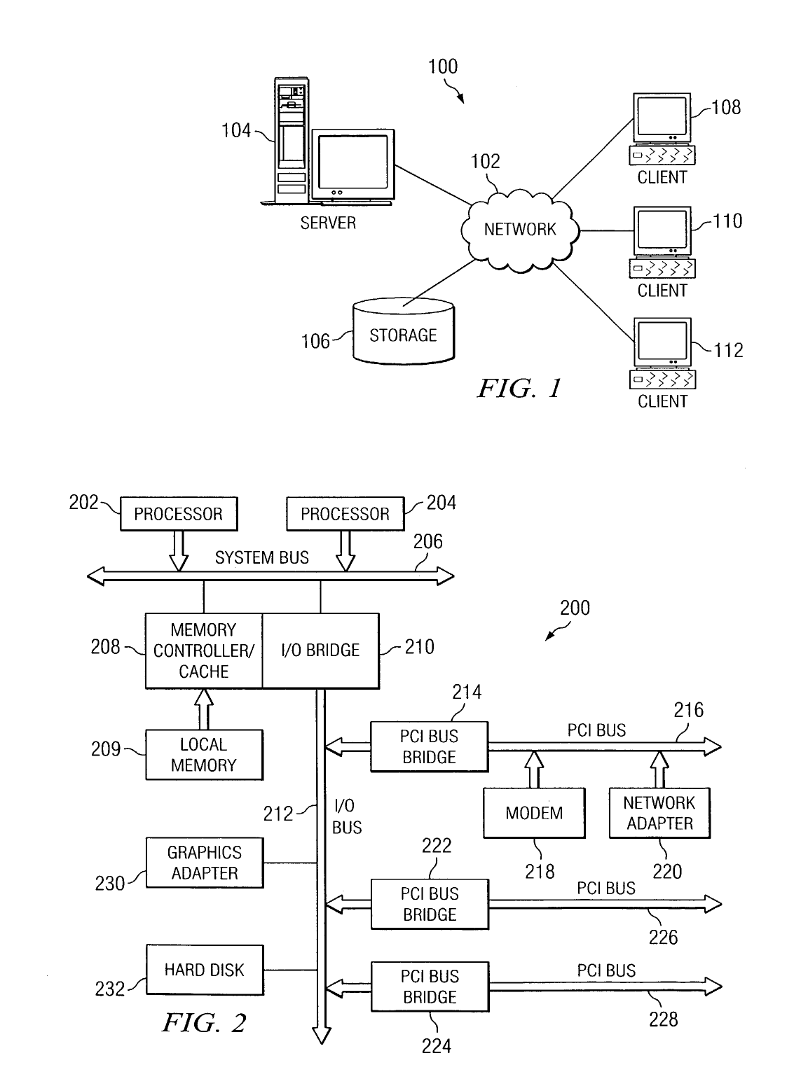

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

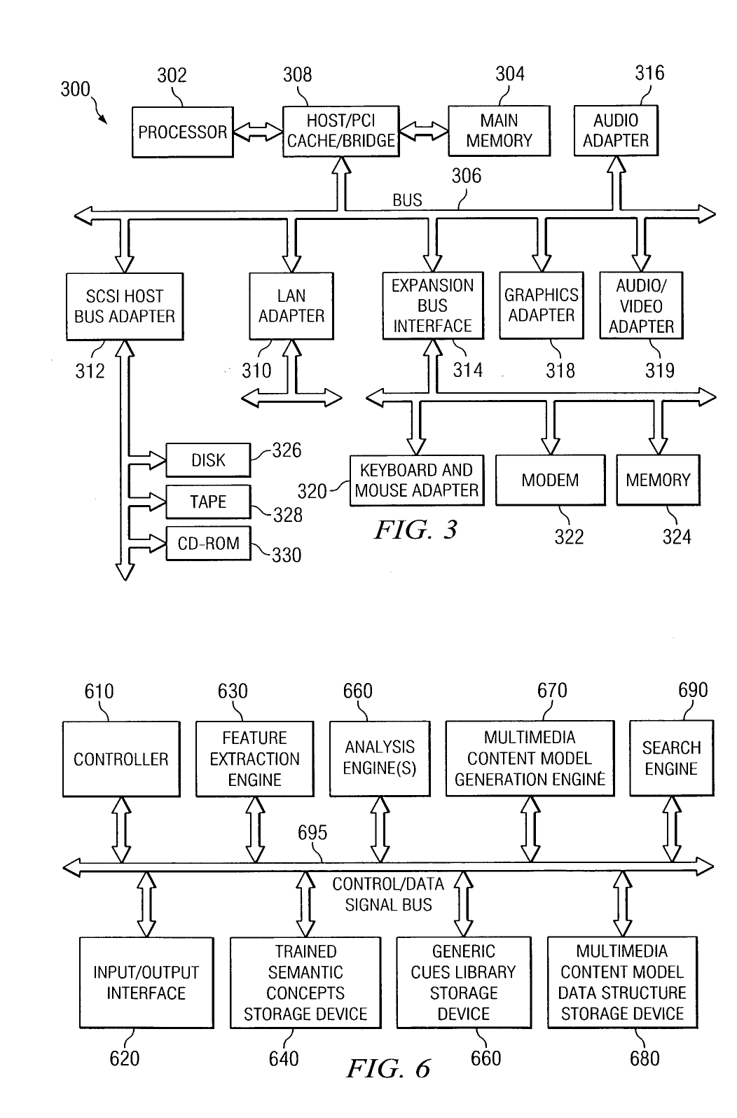

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned previously, the present invention provides a mechanism for analyzing multimedia content to identify the presence of audio, visual and textual cues that together correspond to one or more high-level semantics. The present invention makes use of one or more analysis engines that are trained to identify features extracted from multimedia content and correlate those extracted features to generic cues. In addition, once the generic cues are identified in the extracted features, the one or more analysis engines are trained to identify the relationship of the generic cues to thereby generate a high-level semantic representation of the multimedia content.

For example, in a preferred embodiment, four analysis engines are provided. A first analysis engine is provided for audio data, a second analysis engine is provided for visual data, and a third analysis engine is provided for textual data. The fourth analysis engine is provided for generating high-level semantic representations from the generic cues identified by the other three analysis engines.

These analysis engines may take many forms including expert systems, neural networks, rule-based systems, or the like. Each of the first three analysis engines has an associated feature extraction tool associated with it. The feature extraction tool extracts features for use by the analysis engine to identify cues in the extracted features. For example, the feature extraction tool associated with the first analysis engine may be, for example, a frequency decomposition tool that acts on the audio data stream of the multimedia content. The feature extraction tool associated with the second analysis engine may be a color composition analysis tool, edge identification tool, motion detection tool, and the like. The feature extraction tool for the third analysis engine may be, for example, a speech recognition tool, a closed-captioning tool, and/or simply a text extraction tool that extracts text data from the multimedia content.

The feature extraction tools extract features from the multimedia content and provide them to the analysis engines. The analysis engines analyze the extracted features and make determinations as to the generic cues that are contained within the extracted features. These analysis engines may have associated libraries of generic cues and their corresponding extracted feature patterns. Thus, the analysis engines may perform a comparison of the features extracted from the multimedia content with the extracted feature patterns in the library to thereby identify generic cues.

Since it is unlikely that any multimedia content will generate an exact match to the extracted feature patterns in the libraries, in order to perform analysis of the extracted features, the analysis engines are trained. That is, training data of known multimedia content is entered into the analysis engines and results of the analysis are obtained. A human user then adjusts parameters of the analysis engines to thereby adjust the operation of the analysis engine so that it will generate a correct analysis of the multimedia content. This process is repeated iteratively with the training multimedia content until a correct analysis is obtained.

For example, with a neural network analysis engine, the multimedia content is provided to the extraction tool, the extracted features of the multimedia content is fed into the neural network analysis engine, and resulting generic cues are output based on the analysis performed by the neural network. The results are compared to the actual generic cues that should have been generated by the neural network and, based on this comparison, weights of nodes in the neural network are adjusted to obtain a result that is closer to the result that should have been obtained. This process may be repeated with the same or different training data until consistently correct results are obtained, within a tolerance. Once the training is accomplished, the neural network creates an internal statistical model for the particular generic cue for which it is trained.

In addition to generating the generic cues based on the extracted features, the analysis engines also generate a confidence level associated with the generic cues. When the trained neural network receives input features from an instance of the generic cue or from novel multimedia content, the network compares the deviation between its internal model and the instance at hand and reports this deviation as the confidence-level associated with the generic cue.

As mentioned above, the analysis engines of the present invention are used to generate generic cues that are found in the extracted features of the various modalities, i.e. audio, video and text, of the multimedia content. Examples of these generic cues for an audio modality include music, silence, noise, human speaking, mechanical noise, explosion, etc. Examples of these generic cues for a video modality include sky, outdoors, clouds, human being, animal, automobile, train, rocket, etc. For a text modality, the generic cues may be keywords in textual features extracted from the multimedia content.

The fourth analysis engine takes the generic cues identified by the first three analysis engines and uses them to identify one or more high-level semantic concepts that are most likely to be included in the multimedia content. That is, the fourth analysis engine determines the combination of generic cues from the audio, video and text portions of the multimedia content and generates one or more semantic relationships based on this combination of generic cues. In other words, the generic cues identified by the first three analysis engines are generic in that they may be common to a wide variety of multimedia content. It is the fourth analysis engine that identifies the specific combination of generic cues and thus, the high-level semantics that characterize the multimedia content.

High-level semantics, as the term is used in the present description, is the combination of generic cues to represent the specific concepts contained in the multimedia content. That is, for example, where the generic cues include a rocket, an explosion, and a human speaking, the high-level semantic may be “a commentary on the launching of a rocket.” Other examples of high-level semantics include interviews, monologues, airplane takeoff, symphony, etc.

In order to identify the high-level semantics representative of the multimedia content, the fourth analysis engine may be trained in the same manner as discussed above with regard to the first three analysis engines. In addition, the fourth analysis engine may have a library of semantic concepts that are recognized by the fourth analysis engine. This library of semantic concepts may have a designated combination of generic cues that represent these various semantic concepts.

The fourth analysis engine takes the listing of generic cues identified by the first three analysis engines and compares them against the library of semantic concepts to identify the one or more semantic concepts that match the specific combination of generic cues identified in the multimedia content. The confidence measures associated with each of the generic cues may be used to generate an overall confidence measure associated with the semantic concept. For each trained high-level semantic concept, the system represents this concept in terms of a statistical model. Instead of the statistical model being based on video and audio features as in the case of models for generic cues, the high-level semantic concept model uses the generic cues for building this statistical model. Given a new instance of the high-level concept, a confidence estimate is similarly generated based on the deviation of the observed generic cues from the trained template.

Once the applicable semantics are identified based on the generic cues, and the confidence levels of each semantic are calculated, one or more of these semantics may be used to generate a multimedia content model for the multimedia content. In one exemplary embodiment, only the semantic having the highest confidence is used to generate the multimedia content model. In other embodiments a plurality of the semantics, or all of the semantics with their associated confidences, identified through use of the present invention are used to generate the multimedia content model.

The semantics are associated with labels that may be used as part of a search request for searching for multimedia content. From the semantics identified by the present invention, one or more labels are identified, from a labels database, that describe the semantics of the multimedia content. These labels are stored in a multimedia content model for use by a search engine when searching for multimedia content. This multimedia content model may include a confidence measure for each label, as obtained from the confidence measure of the semantics. This confidence measure may then be used to generate a score for ranking search results by a search engine.

Once the multimedia content is analyzed and a multimedia content model is established for the multimedia content, this multimedia content model may be stored in a data structure that is searchable by a search engine. The search engine according to the present invention allows a user to enter concepts rather than simply search terms. The search engine allows the entering of concepts in that the user may enter terms directed to the particular content that the user wishes and also designate the modality of the multimedia content in which this content is desired.

For example, rather than simply inputting a series of terms such as rocket and launch, the present invention allows a user to input that they wish to see a video of a rocket launch with audio commentary and textual statistics. The search engine may then search each of the labels for the registered multimedia content and identify those pieces of multimedia content that are most likely to satisfy the search request. The search engine may then score each of the identified multimedia content based on their correspondence to the search request and the associated confidence level of the labels matching the search request.

Thus, the present invention provides a mechanism by which multimedia content may be automatically analyzed and modeled based on extracted features, generic cues found in these extracted features, and specific high-level semantics describing the multimedia content. Such analysis and modeling allows a user to search multimedia content based on concepts rather than merely search terms.

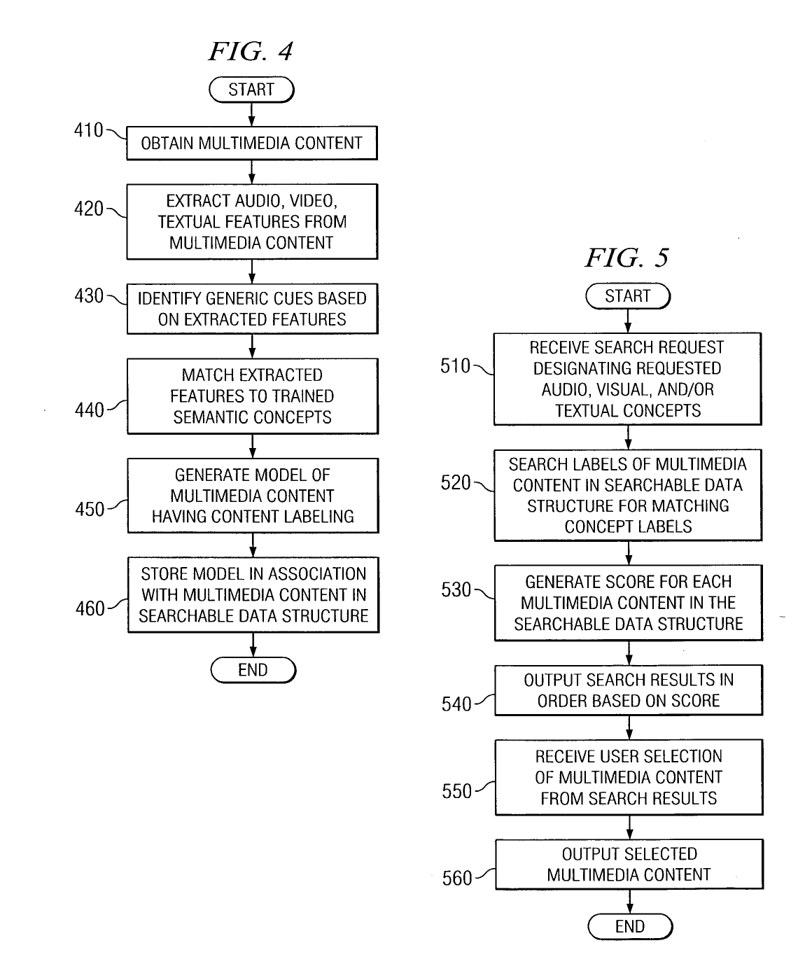

FIG. 4 is a flowchart outlining an exemplary operation of the present invention when analyzing multimedia content to generate a high-level semantic representation of the multimedia content. As shown in FIG. 4, the operation starts by obtaining multimedia content from a multimedia content source (block 410). The multimedia content may be received in response to a supplier requesting that the multimedia content be included in the system of the present invention, for example. Alternatively, a web crawler type device may be used to seek out and retrieve multimedia content from multimedia content sources.

Features for different modalities are extracted from the multimedia content (block 420). For example, frequency decomposition, color feature extraction, speech recognition, and the like, may be employed to extract the features from the audio, video and textual components of the multimedia content. These extracted features are then provided to one or more analysis engines to identify generic cues in the extracted features (block 430).

The generic cues obtained from the one or more analysis engines are then used to match to trained semantic concepts (block 440). The identified semantic concepts are then used to generate a model of the multimedia content that has labels corresponding to the identified semantic concepts (block 450). This model is then stored in association with the multimedia content in a searchable data structure (block 460).

FIG. 5 is a flowchart outlining an exemplary operation of the present invention when retrieving multimedia content based on a high-level semantic representation of the multimedia content. As shown in FIG. 5, the operation starts with the receipt of a search request designating requested audio, visual, and/or textual concepts (block 510). The labels of the registered multimedia content are then searched to identify matching concept labels (block 520).

A score for each multimedia content is generated based on the correspondence of the labels to the search request and corresponding confidence measures (block 530). The search results are then ordered based on their score and output via the search engine (block 540). The user may then send a selection of multimedia content from the search results (block 550) and the selected multimedia content is output (block 560).

FIG. 6 is an exemplary block diagram of a multimedia content representation and retrieval device in accordance with the present invention. The elements shown in FIG. 6 may be implemented as hardware, software, or any combination of hardware and software. In a preferred embodiment, the elements of FIG. 6 are implemented as software instructions executed by one or more processors.

As shown in FIG. 6, the multimedia content representation and retrieval device includes a controller 610, an input/output interface 620, a feature extraction engine 630, a trained semantic concepts storage device 640, analysis engine(s) 650, a generic cues library storage device 660, a multimedia content model generation engine 670, a multimedia content model data structure storage device 680, and a search engine 690. The elements 610-690 are in communication with one another via the control/data signal bus 695. Although a bus architecture is shown in FIG. 6, the present invention is not limited to such and any architecture that facilitates the communication of control and data messages may be used without departing from the spirit and scope of the present invention.

The controller 610 controls the overall operation of the multimedia content representation and retrieval device and orchestrates the operation of the other elements 620-690. The input/output interface 620 provides an interface through which multimedia content is received for analysis, search requests are received from client devices, search results are sent to client devices, selections of multimedia content from search results are received, and the like.

The feature extraction engine 630 contains the necessary engines, algorithms, and the like to extract features for each of the different modalities from multimedia content. These extracted features are provided to the analysis engine(s) 650 which contain the algorithms for analyzing the extracted features to identify generic cues. The generic cues that are recognizable by the analysis engine(s) 650 are stored in the generic cues library storage device 660 in association with the feature patterns representative of the generic cues.

The generic cues identified by the analysis engine(s) 650 are provided to the multimedia content model generation engine 670 which identifies semantic concepts from the generic cues based on the trained semantic concepts stored in the storage device 640. In addition, this storage device 640 may store labels in association with the trained semantic concepts for use in generating the multimedia content model.

The multimedia content model generated through the identification of the semantic concepts from the generic cues and the identification of their corresponding labels, is stored in the multimedia content model data structure storage device 680 for later use in satisfying search requests. The search engine 690 provides a conceptual search engine that allows a user to enter, via their own client device, search requests specifying concepts in terms of the various modalities of the multimedia content, and obtain results identifying multimedia content whose labels in the multimedia content model match the requested concepts.

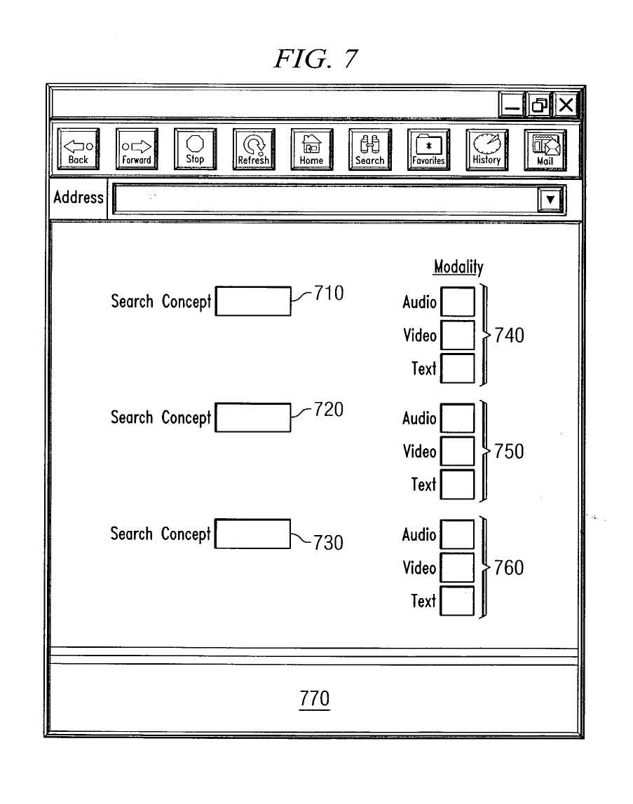

FIG. 7 is an exemplary diagram illustrating a search engine interface according to an exemplary embodiment of the present invention. As shown in FIG. 7, the search engine interface includes a plurality of fields 710-730 for entering conceptual terms that are to be included in the search request. Each of these plurality of fields 710-730 are associated with a modality selector 740-760 that allows the user to select in what modality the user wishes to search for this concept. The combination of the entries into fields 710-730 and the selection of the modality selectors 740-760 is a conceptual search request that is sent to the multimedia content representation and retrieval device.

Based on the search request, the multimedia content representation and retrieval device searches the searchable data structure storing the multimedia content models for labels corresponding to the search request. For example, if the user specified audio narration and video of a rocket launch, multimedia content of a documentary on the United States space program may be retrieved. The search results are presented to the user in a results field 770 of the interface in ranked order based on the correspondence of the labels to the search request and the confidence associated with the labels.

Thus, the present invention provides a mechanism for representing multimedia content in terms of high-level semantic relationships of generic cues in various modalities of the multimedia content. Moreover, the present invention provides a mechanism for searching for multimedia content based on the high-level semantic relationships. In this way, a user is more likely to obtain multimedia content that is relevant to the purposes of the user than would otherwise be obtained through a conventional text search.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of representing multimedia content, comprising:
performing feature extraction on one or more modalities of the multimedia content to extract one or more features of the multimedia content;
identifying one or more generic cues based on the one or more extracted features;
identifying a semantic based on a combination of the one or more generic cues; and
generating a model for the multimedia content based on the identified semantic.

2. The method of claim 1, wherein the one or more modalities include at least one of audio, visual, and textual modalities.

3. The method of claim 1, wherein generating a model for the multimedia content based on the identified semantic includes:
identifying one or more searchable labels based on the semantic; and
storing the one or more labels in a data structure associated with the multimedia content.

4. The method of claim 1, wherein identifying a semantic based on a combination of the one or more generic cues includes:
identifying a plurality of semantics based on the one or more generic cues;
identifying a confidence measure associated with each semantic in the plurality of semantics; and
selecting one or more semantics based on the confidence measure associated with the one or more semantics.

5. The method of claim 4, wherein selecting one or more semantics includes selecting only a semantic having a highest confidence measure.

6. The method of claim 4, wherein selecting one or more semantics includes selecting a subset of semantics in the plurality of semantics.

7. The method of claim 3, further comprising:
storing a confidence measure for each of the searchable labels in association with the searchable labels in the data structure.

8. The method of claim 1, wherein identifying one or more generic cues based on the one or more extracted features includes using at least one of a rule based system, expert system, and a neural network to identify the one or more generic cues based on an internal model generated through training of the rule based system, expert system or neural network.

9. A computer program product in a computer readable medium for representing multimedia content, comprising:
first instructions for performing feature extraction on one or more modalities of the multimedia content to extract one or more features of the multimedia content;
second instructions for identifying one or more generic cues based on the one or more extracted features;
third instructions for identifying a semantic based on a combination of the one or more generic cues; and
fourth instructions for generating a model for the multimedia content based on the identified semantic.

10. The computer program product of claim 9, wherein the one or more modalities include at least one of audio, visual, and textual modalities.

11. The computer program product of claim 9, wherein the fourth instructions for generating a model for the multimedia content based on the identified semantic include:
instructions for identifying one or more searchable labels based on the semantic; and
instructions for storing the one or more labels in a data structure associated with the multimedia content.

12. The computer program product of claim 9, wherein the third instructions for identifying a semantic based on a combination of the one or more generic cues include:
instructions for identifying a plurality of semantics based on the one or more generic cues;
instructions for identifying a confidence measure associated with each semantic in the plurality of semantics; and
instructions for selecting one or more semantics based on the confidence measure associated with the one or more semantics.

13. The computer program product of claim 12, wherein the instructions for selecting one or more semantics include instructions for selecting only a semantic having a highest confidence measure.

14. The computer program product of claim 12, wherein the instructions for selecting one or more semantics include instructions for selecting a subset of semantics in the plurality of semantics.

15. The computer program product of claim 11, further comprising:
instructions for storing a confidence measure for each of the searchable labels in association with the searchable labels in the data structure.

16. The computer program product of claim 9, wherein the second instructions for identifying one or more generic cues based on the one or more extracted features include instructions for using at least one of a rule based system, expert system, and a neural network to identify the one or more generic cues based on an internal model generated through training of the rule based system, expert system or neural network.

17. An apparatus for representing multimedia content, comprising:
means for performing feature extraction on one or more modalities of the multimedia content to extract one or more features of the multimedia content;
means for identifying one or more generic cues based on the one or more extracted features;
means for identifying a semantic based on a combination of the one or more generic cues; and
means for generating a model for the multimedia content based on the identified semantic.

18. A method of searching for multimedia content, comprising:
providing an interface for entering a search request, wherein the interface includes a field for entering a search term and a field for designating a modality corresponding to the search term;
receiving a search request from a client device via the interface, wherein the search request includes a search term and a corresponding modality;
searching a data structure of multimedia content models based on the identified search term and corresponding modality; and
returning results of searching the data structure to the client device.

19. The method of claim 18, wherein the modality is one of audio, video and text.

20. The method of claim 18, wherein the multimedia content models in the data structure include one or more searchable labels generated based on a semantic representation of the multimedia content.

21. The method of claim 20, wherein the semantic representation of the multimedia content is generated based on generic cues obtained from features extracted from the multimedia content.

22. The method of claim 18, wherein searching a data structure of multimedia content models based on the identified search term and corresponding modality includes comparing the search term and corresponding modality to searchable labels stored in the multimedia content models.

23. A computer program product in a computer readable medium for searching for multimedia content, comprising:
first instructions for providing an interface for entering a search request, wherein the interface includes a field for entering a search term and a field for designating a modality corresponding to the search term;
second instructions for receiving a search request from a client device via the interface, wherein the search request includes a search term and a corresponding modality;
third instructions for searching a data structure of multimedia content models based on the identified search term and corresponding modality; and
fourth instructions for returning results of searching the data structure to the client device.

24. The computer program product of claim 23, wherein the modality is one of audio, video and text.

25. The computer program product of claim 23, wherein the multimedia content models in the data structure include one or more searchable labels generated based on a semantic representation of the multimedia content.

26. The computer program product of claim 25, wherein the semantic representation of the multimedia content is generated based on generic cues obtained from features extracted from the multimedia content.

27. The computer program product of claim 23, wherein the third instructions for searching a data structure of multimedia content models based on the identified search term and corresponding modality include instructions for comparing the search term and corresponding modality to searchable labels stored in the multimedia content models.
